(19) United States
(12) Patent Application Publication
(10) Pub. No.: US 2016/0094517 A1
(43) Pub. Date: Mar. 31, 2016

(54) APPARATUS AND METHOD FOR BLOCKING ABNORMAL COMMUNICATION

(71) Applicant: Electronics and Telecommunications Research Institute, Daejeon (KR)

(72) Inventors: Dong-Ho KANG, Daejeon (KR); Byoung-Koo KIM, Daejeon (KR); Jung-Chan NA, Daejeon (KR); Hyun-Sook CHO, Daejeon (KR)

(73) Assignee: Electronics and Telecommunications Research Institute, Daejeon (KR)

(21) Appl. No.: 14/797,562

(22) Filed: Jul. 13, 2015

(30) Foreign Application Priority Data
Sep. 25, 2014 (KR) 10-2014-0128010

(51) Int. Cl. H04L 29/06

(52) U.S. Cl. CPC H04L 63/0236; H04L 63/1425; H04L 63/20

(57) ABSTRACT

An apparatus and method for blocking abnormal communication are disclosed herein. The apparatus for blocking abnormal communication includes a packet collection unit, a packet analysis unit, and an access control unit. The packet collection unit collects a packet via a network device. The packet analysis unit generates a system rule, a communication flow rule, and a packet characteristic rule based on the packet from the packet collection unit. The access control unit determines whether to block the packet by determining whether the packet from the packet collection unit satisfies the system rule, the communication flow rule and the packet characteristic rule.

### CROSS-REFERENCE TO RELATED APPLICATION

This application claims the benefit of Korean Patent Application No. 10-2014-0128010, filed Sep. 25, 2014, which is hereby incorporated by reference herein in its entirety.

### BACKGROUND

1. Technical Field

The present disclosure relates generally to an apparatus and method for blocking abnormal communication and, more particularly, to an apparatus and method for blocking abnormal communication, which are capable of protecting an industrial control system against cyber threats through the traffic analysis of an industrial firewall.

2. Description of the Related Art

Generally, an industrial control system network is divided into a business network including a business system, a Supervisory Control And Data Acquisition (SCADA) network including a system for controlling remote equipment, and a field network including equipment and various types of sensors.

A SCADA system is a system for collecting equipment information and transferring control commands in order to control remote equipment over a communication line. A network including such SCADA systems is referred to as a SCADA network. Pieces of equipment controlled by such SCADA systems are implemented as a field network in a large-sized industrial control system environment, and are implemented as a single piece of equipment in a small-sized case.

Mainly, the communication between a SCADA network and a field network is separated from the outside via a serial port, a modem or other media using a specific control protocol, and corresponds to 1:1 communication in an independent environment. Currently, a standardized control protocol is applied to a SCADA system and the SCADA system is managed in the state of being connected to the Internet for the reasons of an increase in the size of a management target and the convenience of management.

This change means that a cyber security problem in an existing Information Technology (IT) environment also occurs in a SCADA network environment. Recently, the efforts to enhance cyber security in a SCADA network have been made. Accordingly, in order to enhance the security of a SCADA network, firewalls and intrusion detection systems that have been applied to an IT environment are being introduced, or similar systems are being developed.

The intrusion detection systems chiefly employ signature-based intrusion detection technology for detecting already known attacks via attack patterns, and the firewalls chiefly employ access control technology that sets up rules based on a 5-tuple (a sender IP address/port, a recipient IP address/port, and a protocol) via the security management technology of an administrator.

Since the intrusion detection systems and the firewall that have been applied to an existing IT field do not take into account the environmental characteristics of industrial control systems, criteria for the determination of illegitimate access are based on the application of external signatures or application by an administrator, so that they have difficulty performing effective protection.

These security technologies have a disadvantage in that the updating of rules should be periodically and remotely performed in order to perform detection and blocking. Most pieces of industrial equipment are placed in an environment in which it is impossible to periodically update security rules due to the blocking of access to the external Internet and difficulty with management. Accordingly, there is a need for an industrial firewall that supports automatic security rule setup that does not require the updating of rules via an external system.

SCADA networks are configured such that there are few changes in network topology and internal systems are fixed or are rarely changed, unlike IT networks. Furthermore, communication protocols between the systems have constant and limited types and forms that can be predicted.

As a related technology, U.S. Patent Application No. 2013-0263244 entitled “Reverse Firewall with Self-Provisioning” discloses a security technology in which a firewall manages a host profile in order to determine whether to allow or block network communication performed via an application program of a host.

As another related technology, a technology that extracts a normal traffic flow in a SCADA network environment and applies the normal traffic flow to a whitelist firewall is disclosed in the paper by Rafael Ramos, Regis Barbosa, Ramin Sadre, and Aiko Pras, “Flow Whitelisting in SCADA Networks,” International Journal of Critical Infrastructure Protection, Aug. 20, 2013.

### SUMMARY

At least some embodiments of the present invention are directed to the provision of an apparatus and method for blocking abnormal communication, which, upon initially constructing a SCADA network or in a situation in which it can be considered that infringement is not currently present based on the determination of an administrator, extract a normal traffic pattern between systems in a boundary area between networks, define and apply the normal traffic pattern as a normal communication rule, and block cyber attacks via the access control of abnormal communication patterns based on the normal communication pattern rule.

In accordance with an aspect of the present invention, there is provided an apparatus for blocking abnormal communication, including: a packet collection unit configured to collect a packet via a network device; a packet analysis unit configured to generate a system rule, a communication flow rule, and a packet characteristic rule based on the packet from the packet collection unit; and an access control unit configured to determine whether to block the packet by determining whether the packet from the packet collection unit satisfies the system rule, the communication flow rule and the packet characteristic rule.

The packet collection unit may transfer the packet to any one of the packet analysis unit and the access control unit according to a mode selected from an in-line installation mode and an in-line illegitimate access control mode.

The packet collection unit may transfer the packet to the access control unit when the in-line illegitimate access control mode has been set.

The packet collection unit may collect the packet from one or more of the inside of a Supervisory Control And Data Acquisition (SCADA) network and the space between the SCADA network and a field network.

The packet analysis unit may include: a system analysis unit configured to extract fields of specific headers of the packet from the packet collection unit, and to generate the system rule using information of the corresponding fields; a communication flow analysis unit configured to extract fields of specific headers of the packet from the packet collection unit, and to generate the communication flow rule using information of the corresponding fields; and a packet characteristic analysis unit configured to extract fields of a specific header of the packet from the packet collection unit, and to generate the packet characteristic rule using information of the corresponding fields.

The packet analysis unit may further include a communication pattern map generation unit configured to generate a communication pattern map based on the system rule, the communication flow rule, and the packet characteristic rule.

The apparatus may further include a rule database configured to store the system rule, the communication flow rule, and the packet characteristic rule.

The system rule may include the name of the network device that has received the packet, a transmission MAC address, and a transmission IP address.

The communication flow rule may include a protocol, transmission and reception IP addresses, and a transmission and reception port.

The packet characteristic rule may include a header length, a total length, a flag, and time to live (TTL).

The access control unit may include: a system access control unit configured to determine whether the packet from the packet collection unit violates the system rule, and to determine whether to block the corresponding packet; a communication flow access control unit configured to determine whether the packet from the packet collection unit violates the communication flow rule, and to determine whether to block the corresponding packet; and a packet characteristic access control unit configured to determine whether the packet from the packet collection unit violates the packet characteristic rule, and to determine whether to block the corresponding packet.

The access control unit may determine whether to block the packet according to a set security mode, in which case, when the security mode has been set to a “high” level, the access control unit determines that the packet will be allowed if the packet satisfies all of the system rule, the communication flow rule, and the packet characteristic rule.

The access control unit may determine whether to block the packet according to a set security mode, in which case, when the security mode has been set to a “middle” level, the access control unit determines that the packet will be allowed if the packet satisfies the communication flow rule and the packet characteristic rule.

The access control unit may determine whether to block the packet according to a set security mode, in which case, when the security mode has been set to a “low” level, the access control unit determines that the packet will be allowed if the packet satisfies the system rule.

In accordance with another aspect of the present invention, there is provided a method of blocking abnormal communication, including: collecting, by a packet collection unit, a packet via a network device; generating, by a packet analysis unit, a system rule, a communication flow rule, and a packet characteristic rule based on the collected packet; and determining, by an access control unit, whether the packet from the packet collection unit satisfies the system rule, the communication flow rule and the packet characteristic rule, and determining, by an access control unit, whether to block the packet according to a set security mode, in which case: when the security mode has been set to a “high” level, it is determined that the packet will be allowed if the packet satisfies all of the system rule, the communication flow rule, and the packet characteristic rule; when the security mode has been set to a “middle” level, it is determined that the packet will be allowed if the packet satisfies the communication flow rule and the packet characteristic rule; and when the security mode has been set to a “low” level, it is determined that the packet will be allowed if the packet satisfies the system rule.

The generating may include: extracting fields of specific headers of the collected packet, and generating the system rule using information of the corresponding fields; extracting fields of specific headers of the collected packet, and generating the communication flow rule using information of the corresponding fields; and extracting fields of a specific header of the collected packet, and generating the packet characteristic rule using information of the corresponding fields.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the structure of an industrial control system to which the present invention is applied;

FIG. 2 is a diagram illustrating an example in which the apparatus of the present invention has been installed;

FIG. 3 is a diagram illustrating the configuration of an apparatus for blocking abnormal communication according to an embodiment of the present invention;

FIG. 4 is a diagram illustrating the fields of a packet header that are extracted by the packet analysis unit illustrated in FIG. 3;

FIG. 5 is a diagram illustrating an example of representing the results of analysis, performed by the packet analysis unit illustrated in FIG. 3, in the form of a communication map;

FIG. 6 is a diagram illustrating examples of a system rule generated by the system analysis unit illustrated in FIG. 3;

FIG. 7 is a diagram illustrating examples of a communication flow rule generated by the communication flow analysis unit illustrated in FIG. 3;

FIG. 8 is a diagram illustrating examples of a packet characteristic rule generated by the packet characteristic analysis unit illustrated in FIG. 3;

FIG. 9 is a diagram illustrating an example of the linkages between related rules with respect to a single packet;

FIGS. 10A, 10B and 11 are diagrams illustrating examples of blocking by the system access control unit illustrated in FIG. 3;

FIG. 12 is a diagram illustrating an example of blocking by the communication flow access control unit illustrated in FIG. 3;

FIG. 13 is a diagram illustrating an example of blocking by the packet characteristic access control unit illustrated in FIG. 3; and

FIG. 14 is a flowchart illustrating a method of blocking abnormal communication according to an embodiment of the present invention.

### DETAILED DESCRIPTION

The present invention may be subjected to various modifications and have various embodiments. Specific embodiments are illustrated in the drawings and described in detail below.

However, it should be understood that the present invention is not intended to be limited to these specific embodiments but is intended to encompass all modifications, equivalents and substitutions that fall within the technical spirit and scope of the present invention.

The terms used herein are used merely to describe embodiments, and not to limit the inventive concept. A singular form may include a plural form, unless otherwise defined. The terms, including “comprise,” “includes,” “comprising,” “including” and their derivatives specify the presence of described shapes, numbers, steps, operations, elements, parts, and/or groups thereof, and do not exclude presence or addition of at least one other shapes, numbers, steps, operations, elements, parts, and/or groups thereof.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Embodiments of the present invention are described in greater detail below with reference to the accompanying drawings. In order to facilitate the general understanding of the present invention, like reference numerals are assigned to like components throughout the drawings and redundant descriptions of the like components are omitted.

The present invention is intended for the security of systems in a SCADA network and the pieces of equipment, such as a PLC, and an IED, of a field network against cyber threats.

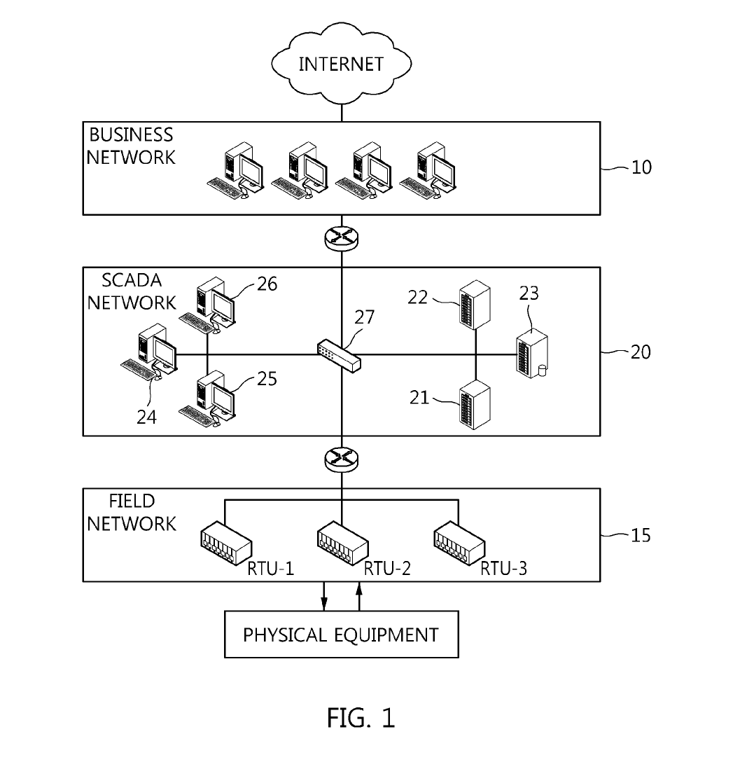

FIG. 1 is a diagram illustrating the structure of an industrial control system to which the present invention is applied.

The industrial control system includes a business network 10 performing general business processing, a SCADA network 20 including systems for collecting equipment information and transferring control commands in order to control equipment at a remote location, and a field network 15 including systems for monitoring the equipment and executing commands.

In this case, the scope of the present invention is limited to the SCADA network 20 including its component systems and the field network 15 including its component systems, exclusive of the business network 10.

The SCADA network 20 may be divided into small-sized network areas depending on the functions or locations of installation of internal systems. An example of the SCADA network 20 may include servers (SCADA server-1 21, SCADA server-2 22, and SCADA server-3 23) for directly collecting equipment information and transferring control commands and a system (operation PC-1 24, operation PC-2 25, and operation PC-3 26) for operating the servers.

In FIG. 1, reference symbol 27 denotes a remote terminal unit (RTU). The RTU 27 collects data and transmits the collected data to the SCADA server, or receives a control command from the SCADA server and performs control online in real time.

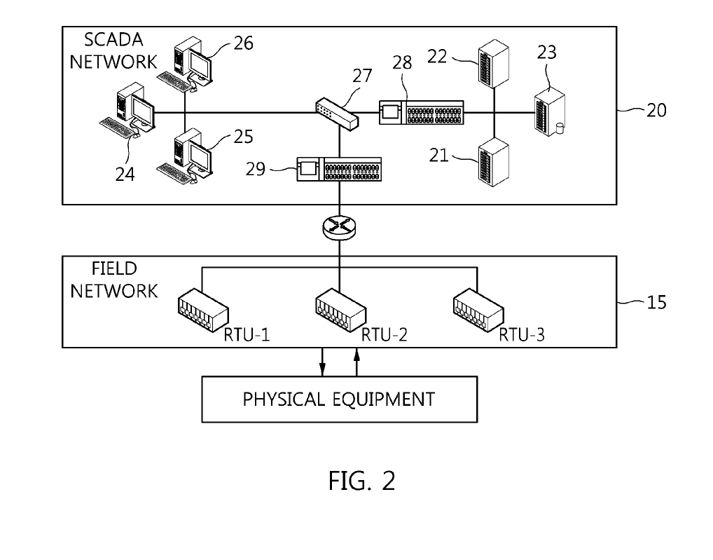

FIG. 2 is a diagram illustrating an example in which the apparatus of the present invention has been installed.

The present invention is intended to analyze communication between the small-sized network areas or communication traffic between the SCADA network 20 and the field network 15 and to prevent illegitimate access upon communication between networks.

For this purpose, apparatuses for blocking abnormal communication (also called access control apparatuses) 28 and 29 according to an embodiment of the present invention are located between the function-based small-sized networks of the SCADA network 20 in order to protect the SCADA servers 21, 22 and 23 of the SCADA network 20, as illustrated in FIG. 2, or between the SCADA network 20 and the field network 15 in order to protect internal systems of the field network 15, and performs their functions.

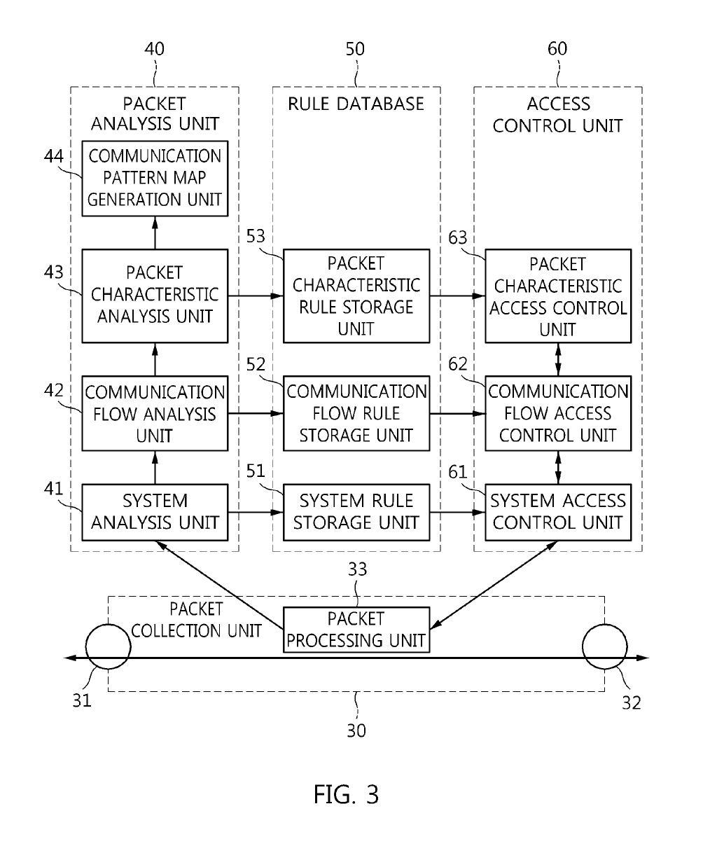

FIG. 3 is a diagram illustrating the configuration of each of the apparatuses 28 and 29 for blocking abnormal communication according to an embodiment of the present invention.

Each of the apparatuses 28 and 29 for blocking abnormal communication according to the present embodiment includes a packet collection unit 30, a packet analysis unit 40, a rule database 50, and an access control unit 60.

The packet collection unit 30 collects packets in an in-line manner.

The packet analysis unit 40 generates predetermined rules based on the packets collected by the packet collection unit 30, and analyzes the communication pattern of the corresponding packets based on the generated rules.

The rule database 50 stores the generated rules via the packet analysis unit 40.

The access control unit 60 performs access control on packets based on the rule database 50.

More specifically, the packet collection unit 30 includes network devices 31 and 32, and a packet processing unit 33. The network devices 31 and 32 collect in-line packets. The packet processing unit 33 transfers packets collected by the two network devices 31 and 32 to the packet analysis unit 40 and the access control unit 60 in order to analyze the packets and perform access control on the packets. In this case, the packet processing unit 33 may support an in-line installation mode and an in-line illegitimate access control mode. In the in-line installation mode, an analysis function is processed in order to generate a communication pattern. In contrast, in the in-line illegitimate access control mode, an access control function is performed on approaching packets based on the rules. These modes may be manually selected by an administrator. Accordingly, the packet processing unit 33 receives a packet and transfers the packet to the packet analysis unit 40 when the in-line installation mode has been set, and transfers a received packet to the access control unit 60 when the in-line illegitimate access control mode has been set.

Meanwhile, the packet analysis unit 40 includes a system analysis unit 41, a communication flow analysis unit 42, a packet characteristic analysis unit 43, and a communication pattern map generation unit 44. The system analysis unit 41 generates a system rule. The communication flow analysis unit 42 generates a communication flow rule. The packet characteristic analysis unit 43 generates a packet characteristic rule. The communication pattern map generation unit 44 generates a communication pattern map.

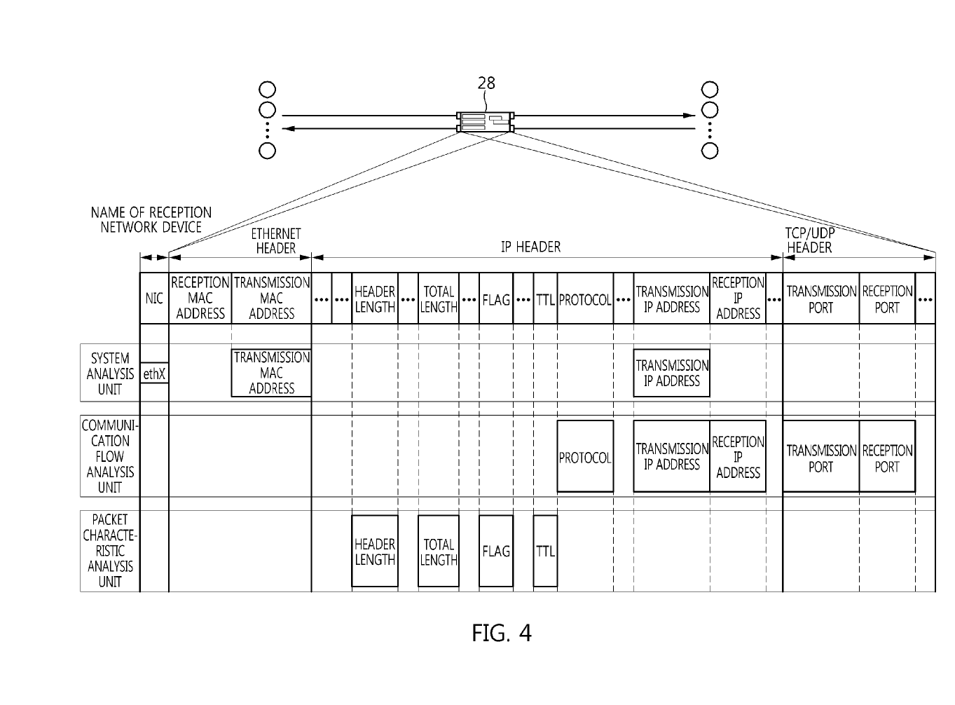

In this case, each of the system analysis unit 41, the communication flow analysis unit 42 and the packet characteristic analysis unit 43 extracts the fields of respective headers upon receiving a single packet, as illustrated in FIG. 4.

The system analysis unit 41 extracts the name (for example, eth0, eth1, . . . ) of a network device having received a packet, a transmission MAC address, and a transmission IP address from the fields of a reception network device name header, an Ethernet header, and an IP header, as illustrated in FIG. 4, generates a single system rule, and stores the generated system rule in the system rule storage unit 51 of the rule database 50, thereby completing the system rule.

The communication flow analysis unit 42 extracts a protocol, transmission and reception IP addresses, and a transmission and reception port from the fields of an IP header and a TCP/UDP header, as illustrated in FIG. 4, and generates a single communication flow rule. Furthermore, the communication flow analysis unit 42 stores the generated communication flow rule in the communication flow rule storage unit 52 of the rule database 50, thereby completing the communication flow rule. The transmission and reception port that matches a port included in an allowable port list previously defined by an administrator is registers as the application protocol of the communication flow rule. The allowable port list is composed of pairs of an application protocol name and a port number, and defines control application protocols. An example of the allowable port list is shown in Table 1 below:

TABLE 1

| Control Application Protocol | Port Number |
|---|---|
| MODBUS-TCP | 502 |
| EtherNet/IP | 2222 |
| OPC | 3480 |
| ABB Ranger 2003 | 12316 |
| DNP3 | 20000 |
| PROFINET | 34962 |
| . . . | . . . |

The packet characteristic analysis unit 43 extracts a header length, a total length, a flag, and time to live (TTL) from the fields of the IP header, as illustrated in FIG. 4, generates a single packet characteristic rule, and stores the generated packet characteristic rule in the packet characteristic rule storage unit 53 of the rule database 50, thereby completing the packet characteristic rule.

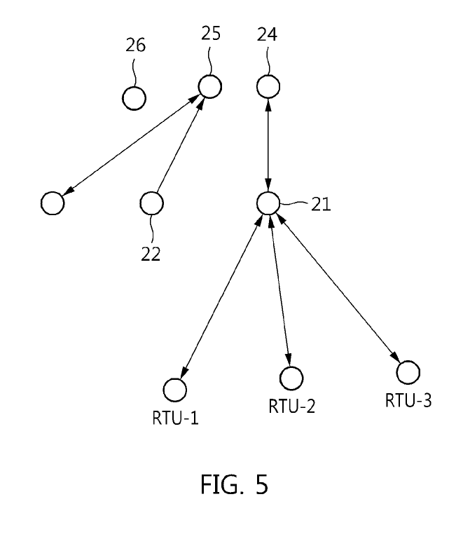

The communication pattern map generation unit 44 generates a communication pattern map based on the rules generated by the system analysis unit 41, the communication flow analysis unit 42 and the packet characteristic analysis unit 43. An example of the communication pattern map generated by the communication pattern map generation unit 44 is illustrated in FIG. 5. In FIG. 5, each node represents a system, and each arrow indicates that communication has been performed between sub-network component systems.

In FIG. 5, a communication pattern map between operation PCs 24, 25 and 26 and SCADA servers 21 and 22 is generated by the packet analysis unit 40 of an access control apparatus 28, and a communication pattern map between the SCADA servers 21 and 22 and RTU equipment (RTU-1, RTU-2, and RTU-3) is generated by the packet analysis unit 40 of an access control apparatus 29. As described above, the access control apparatuses 28 and 29 may be viewed as the apparatuses for blocking abnormal communication according to the present invention.

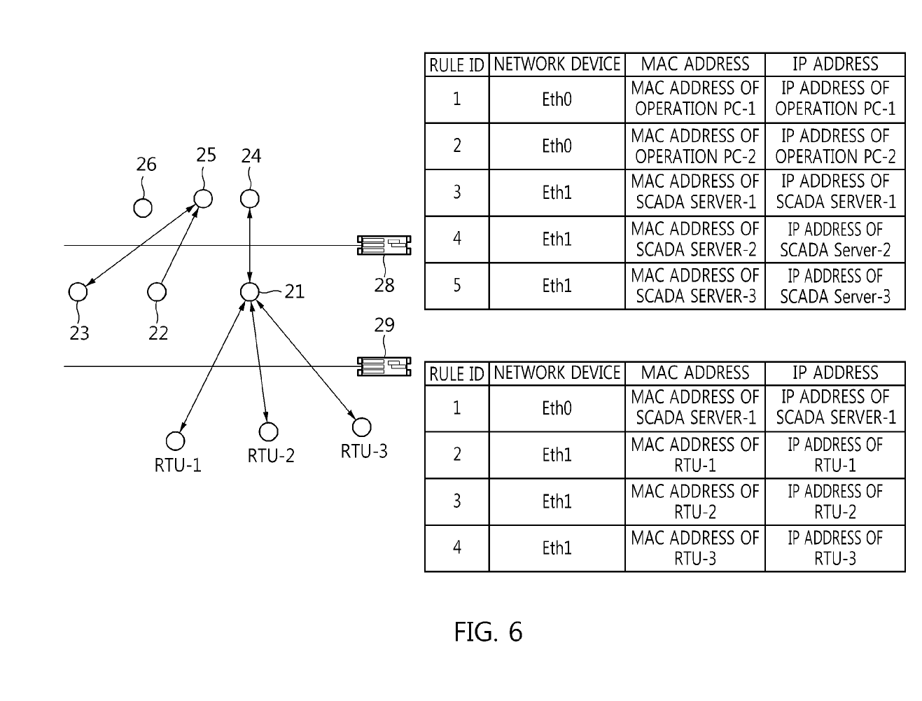

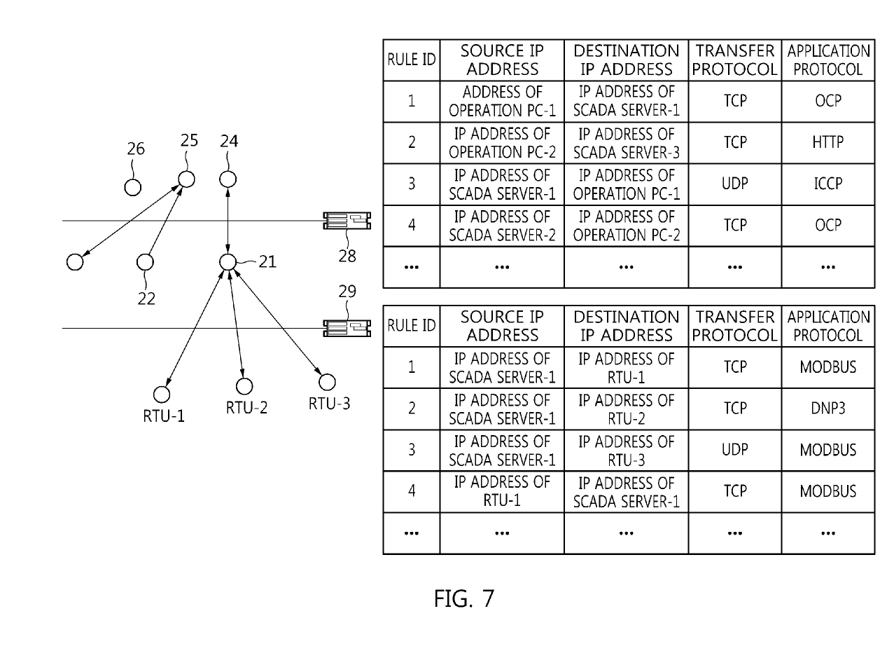

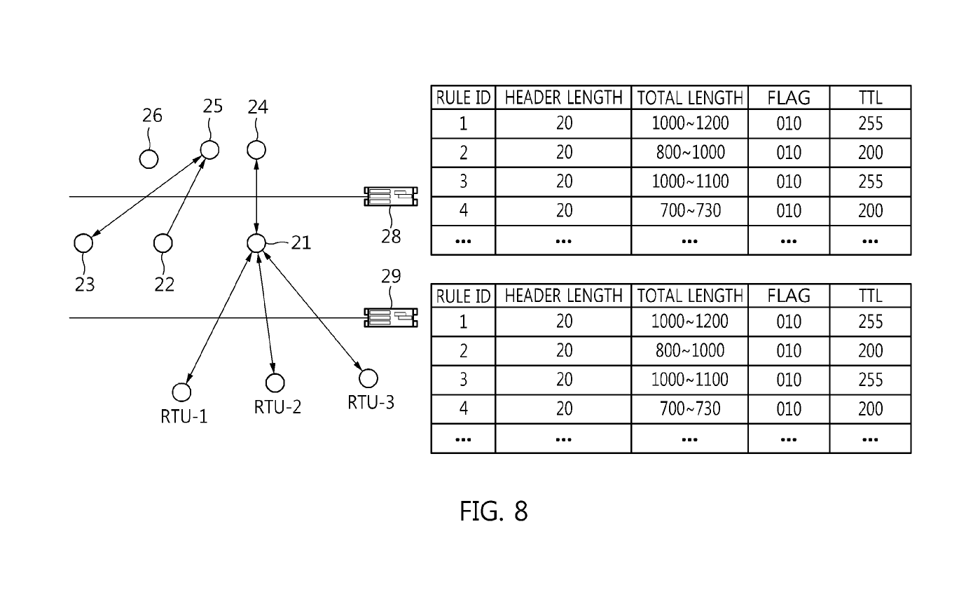

Meanwhile, the rule database 50 includes a system rule storage unit 51, a communication flow rule storage unit 52, and a packet characteristic rule storage unit 53. Only the forms of packets registered in the rules of the system rule storage unit 51, the communication flow rule storage unit 52 and the packet characteristic rule storage unit 53 allow corresponding packets. The system rules of the system rule storage unit 51 are completed by the system analysis units 41 of the respective access control apparatuses 28 and 29 in a form, such as that illustrated in FIG. 6. That is, a system rule including a network device name, a transmission MAC address, and a transmission IP address extracted from a single packet by the access control apparatus-based system analysis unit 41 is stored in the system rule storage unit 51. The communication flow rules of the communication flow rule storage unit 52 are completed by the communication flow analysis units 42 of the respective access control apparatuses 28 and 29 in a form, such as that illustrated in FIG. 7. That is, a communication flow rule including a protocol, transmission and reception IP addresses, and a transmission and reception port extracted from a single packet by the access control apparatus-based communication flow analysis unit 42 is stored in the communication flow rule storage unit 52. The packet characteristic rules of the packet characteristic rule storage unit 53 are completed by the packet characteristic analysis units 43 of the respective access control apparatuses 28 and 29 in a form, such as that illustrated in FIG. 8. That is, a packet characteristic rule including a header length, a total length, a flag, and TTL extracted from a single packet by the access control apparatus-based packet characteristic analysis units 43 is stored in the packet characteristic rule storage unit 53.

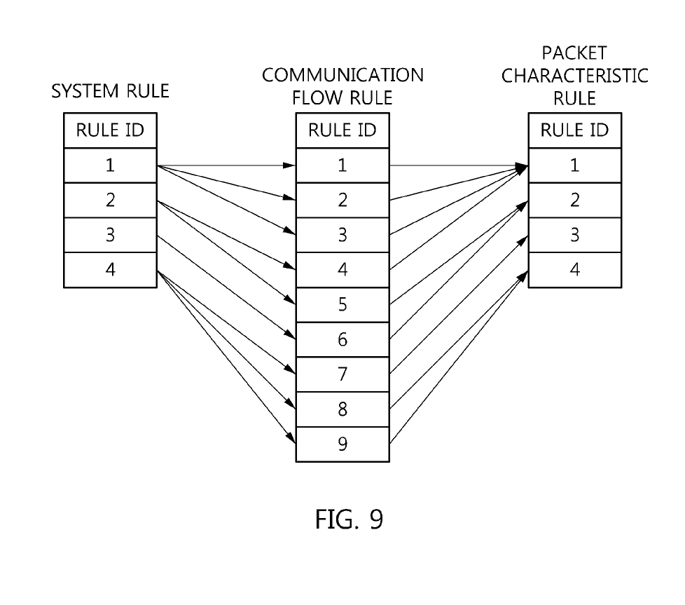

As described above, three types of rules (a system rule, a communication flow rule, and a packet characteristic rule) are generated with respect to a single packet, and a redundant rule is not registered. In order to define the relationship between three types of rules with respect to a single packet, the fields of the table of each rule are managed in the form of a linked list, as illustrated in FIG. 9. For example, in FIG. 9, system rule Rule ID 1, communication flow rule Rule ID 1 and packet characteristic rule Rule ID 1 are viewed as rules that are generated by a single packet. System rule Rule ID 1, communication flow rule Rule ID 2 and packet characteristic rule Rule ID 1 are correlated as rules generated by another single packet.

Meanwhile, the access control unit 60 includes a system access control unit 61, a communication flow access control unit 62, and a packet characteristic access control unit 63. The access control unit 60 operates upon applying a system protection function to the SCADA network 20 and the field network 15 after the analysis of a packet has been completely completed. Accordingly, when the security function starts, the packet processing unit 33 of the packet collection unit 30 does not transfer a collected packet to the packet analysis unit 40 any longer, and transfers it to the access control unit 60. The three access control methods of the access control unit 60 may selectively perform functionality via a security administrator depending on the level of a security mode (for example, a high level: the functionalities of the three control units 61, 62 and 63 are turned on; a middle level: the functionalities of the packet characteristic access control unit 63 and the communication flow access control unit 62 are turned on; or the functionality of the system access control unit 61 is turned on) and the degree of availability.

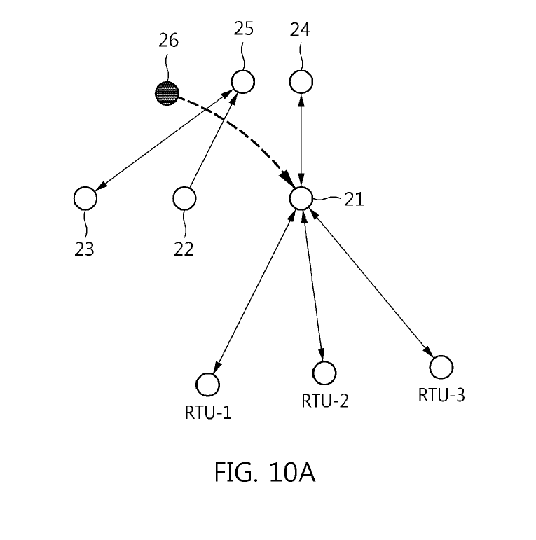

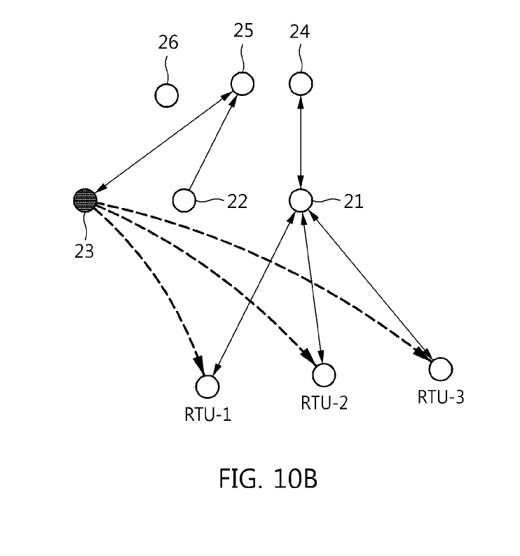

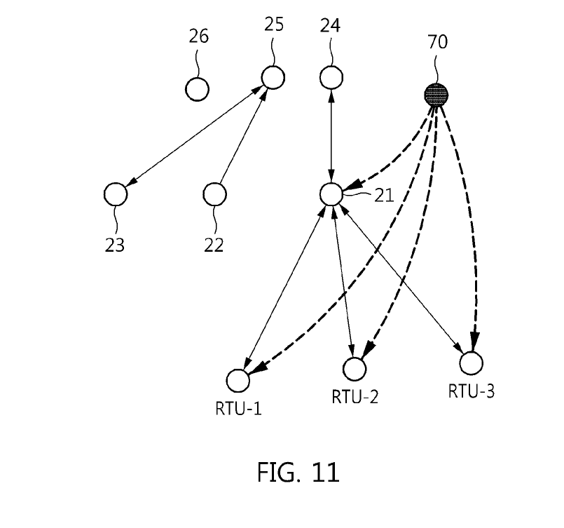

In this case, the system access control unit 61 receives a packet from the packet processing unit 33, and determines whether the packet is a packet transmitted from an allowed system registered in the system rule storage unit 51. For example, in the case of the attempt for a registered system (that is, the operation PC 26) to access the SCADA server 21, as illustrated in FIG. 10A, or the attempt for a registered system (that is, the SCADA server 23) to access the RTU equipment (RTU-1, RTU-2, or RTU-3), as illustrated in FIG. 10B, the system access control unit 61 does not transfer a command to block a corresponding packet to the packet processing unit 33. However, when a packet related to the attempt for the system 70, not registered in the system rule storage unit 51, to access another sub-network or network is received, as illustrated in FIG. 11, the system access control unit 61 transfers a command to block the corresponding packet to the packet processing unit 33.

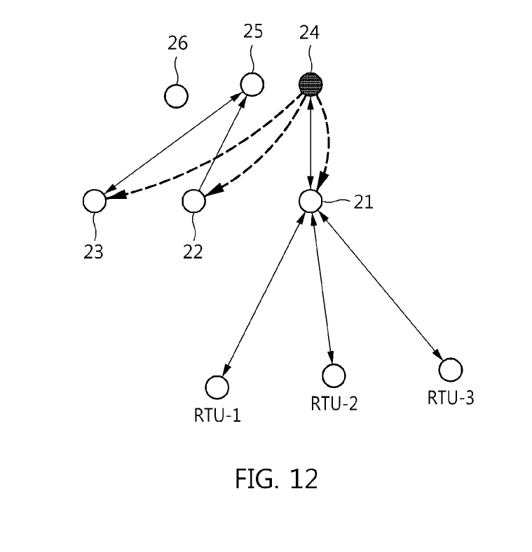

The communication flow access control unit 62 receives a packet from the packet processing unit 33, and determines whether the packet is a packet registered in the communication flow rule storage unit 52. For example, when the attempt, such as that in the example of FIG. 12, is made, the system access control unit 61 does not transfer a blocking command because a corresponding system rule is not violated. However, the communication flow access control unit 62 transfers a command to block a corresponding packet to the packet processing unit 33 because an access attempt that violates the communication flow rule (the operation PC-1 24→the SCADA server-2 22, and the operation PC-1 24→SCADA server-3 23) is made. A packet that attempts access from the operation PC-1 24 to the SCADA server-1 21 is selectively blocked and allowed depending on whether a value that is the same as a value in the application protocol and protocol rule fields of the communication flow rules of the communication flow rule storage unit 52 is present.

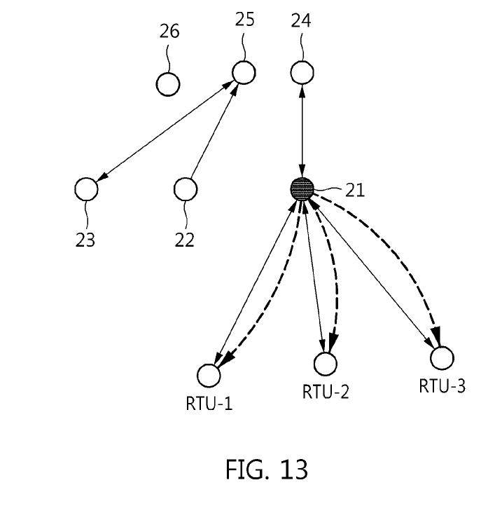

The packet characteristic access control unit 63 determines whether a packet having been allowed through the system access control unit 61 or communication flow access control unit 62 is a packet in the range of the packet characteristic rules of the packet characteristic rule storage unit 53. For example, when an attempt, such as that in the example of FIG. 13, is made, the system access control unit 61 and communication flow access control unit 62 do not transfer the command to block a corresponding packet. However, the packet specific access control unit 63 determines whether the packet is similar to an existing normal packet via the size of a normal packet exchanged between communication systems and option (TTL and flag) information. If the packet is a packet that violates the packet characteristic rule, the packet characteristic access control unit 63 determines that the corresponding packet is an abnormal packet, and transfers a command to block the corresponding packet to the packet processing unit 33.

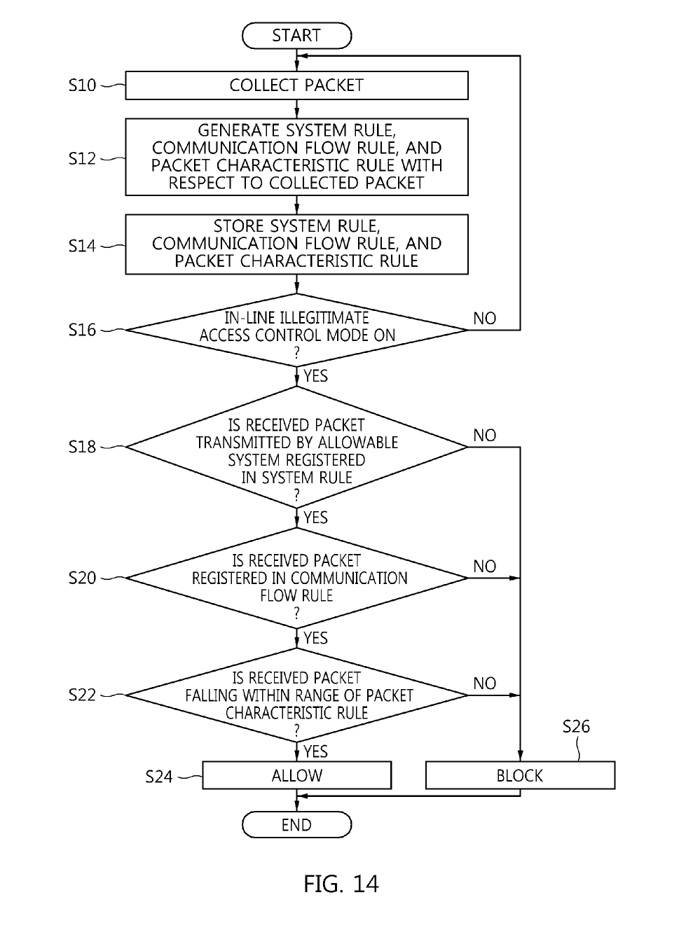

FIG. 14 is a flowchart illustrating a method of blocking abnormal communication according to an embodiment of the present invention.

First, it is assumed that an in-line installation mode has been set by an administrator.

In this case, the packet processing unit 33 of the packet collection unit 30 transfers a packet, received via the network device 31 or 32, to the packet analysis unit 40 at step S10.

Thereafter, when receiving a single packet via the packet processing unit 33, the packet analysis unit 40 extracts the fields of the individual headers of the corresponding packet, and generates a system rule (including the name of the network device that has received the packet, a transmission MAC address, and a transmission IP address), a communication flow rule (including a protocol, transmission and reception IP addresses, and a transmission and reception port), and a packet characteristic rule (including a header length, a total length, a flag, and TTL) at step S12.

Thereafter, the packet analysis unit 40 stores (registers) the generated system rule, communication flow rule and packet characteristic rule in the rule database 50 at step S14.

Thereafter, when the administrator sets an in-line illegitimate access control mode (“YES” at step S16), the packet processing unit 33 transfers the received packet to the access control unit 60. When the security function starts as described above, the packet processing unit 33 of the packet collection unit 30 does not transfer the collected packet to the packet analysis unit 40 any longer. Meanwhile, it is assumed that a current security mode has been set to a “high” level.

Accordingly, the access control unit 60 determines the received packet to be a packet transmitted from an allowed system registered in the system rule, a packet registered in the communication flow rule, or a packet in the range of the packet characteristic rule at steps S18, S20 and S22.

That is, the access control unit 60 determines that the corresponding packet is a normal packet if the packet satisfies all the three types of rules and transfers an allow command to the packet processing unit 33 at step S24.

In contrast, the access control unit 60 determines that the corresponding packet is an abnormal packet if the packet violates any one of the three types of rules and transfers a blocking command to the packet processing unit 33 at step S26.

The above description is directed to the case where the security mode has been set to a “high” level. In contrast, in the case where the security mode has been set to a “middle” level, a packet in question is determined to be a normal packet even when the former packet satisfies only the communication flow rule and the packet characteristic rule. In contrast, in the case where the security mode has been set to a “low” level, a packet in question is determined to be a normal packet even when the former packet satisfies only the system rule.

According to at least some embodiments of the present invention, a normal communication pattern can be extracted upon initially constructing a SCADA network or in a situation in which it can be considered that a SCADA network is secure, rules are generated based on the extracted normal communication pattern, and only normal communication is allowed, thereby reducing the erroneous detections and non-detections of an intrusion prevention system in an existing IT field.

As described above, the optimum embodiments have been disclosed in the drawings and the specification. Although specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true range of protection of the present invention should be defined based on the technical spirit of the attached claims.

What is claimed is:

1. An apparatus for blocking abnormal communication, comprising:
a packet collection unit configured to collect a packet via a network device;
a packet analysis unit configured to generate a system rule, a communication flow rule, and a packet characteristic rule based on the packet from the packet collection unit; and
an access control unit configured to determine whether the packet from the packet collection unit satisfies the system rule, the communication flow rule and the packet characteristic rule, and to determine whether to block the packet according to a set security mode, in which case:
when the security mode has been set to a “high” level, the access control unit determines that the packet will be allowed if the packet satisfies all of the system rule, the communication flow rule, and the packet characteristic rule;
when the security mode has been set to a “middle” level, the access control unit determines that the packet will be allowed if the packet satisfies the communication flow rule and the packet characteristic rule; and
when the security mode has been set to a “low” level, the access control unit determines that the packet will be allowed if the packet satisfies the system rule.

2. The apparatus of claim 1, wherein the packet collection unit transfers the packet to any one of the packet analysis unit and the access control unit according to a mode selected from an in-line installation mode and an in-line illegitimate access control mode.

3. The apparatus of claim 2, wherein the packet collection unit transfers the packet to the access control unit when the in-line illegitimate access control mode has been set.

4. The apparatus of claim 1, wherein the packet collection unit collects the packet from one or more of an inside of a Supervisory Control And Data Acquisition (SCADA) network and a space between the SCADA network and a field network.

5. The apparatus of claim 1, wherein the packet analysis unit comprises:
a system analysis unit configured to extract fields of specific headers of the packet from the packet collection unit, and to generate the system rule using information of the corresponding fields;
a communication flow analysis unit configured to extract fields of specific headers of the packet from the packet collection unit, and to generate the communication flow rule using information of the corresponding fields; and
a packet characteristic analysis unit configured to extract fields of a specific header of the packet from the packet collection unit, and to generate the packet characteristic rule using information of the corresponding fields.

6. The apparatus of claim 5, wherein the packet analysis unit further comprises a communication pattern map generation unit configured to generate a communication pattern map based on the system rule, the communication flow rule, and the packet characteristic rule.

7. The apparatus of claim 1, further comprising a rule database configured to store the system rule, the communication flow rule, and the packet characteristic rule.

8. The apparatus of claim 1, wherein the system rule comprises a name of the network device that has received the packet, a transmission MAC address, and a transmission IP address.

9. The apparatus of claim 1, wherein the communication flow rule comprises a protocol, transmission and reception IP addresses, and a transmission and reception port.

10. The apparatus of claim 1, wherein the packet characteristic rule comprises a header length, a total length, a flag, and time to live (TTL).

11. The apparatus of claim 1, wherein the access control unit comprises:
a system access control unit configured to determine whether the packet from the packet collection unit violates the system rule, and to determine whether to block the corresponding packet;
a communication flow access control unit configured to determine whether the packet from the packet collection unit violates the communication flow rule, and to determine whether to block the corresponding packet; and
a packet characteristic access control unit configured to determine whether the packet from the packet collection unit violates the packet characteristic rule, and to determine whether to block the corresponding packet.

12. A method of blocking abnormal communication, comprising:
collecting, by a packet collection unit, a packet via a network device;
generating, by a packet analysis unit, a system rule, a communication flow rule, and a packet characteristic rule based on the collected packet; and
determining, by an access control unit, whether the packet from the packet collection unit satisfies the system rule, the communication flow rule and the packet characteristic rule, and determining, by an access control unit, whether to block the packet according to a set security mode, in which case:
when the security mode has been set to a “high” level, it is determined that the packet will be allowed if the packet satisfies all of the system rule, the communication flow rule, and the packet characteristic rule;
when the security mode has been set to a “middle” level, it is determined that the packet will be allowed if the packet satisfies the communication flow rule and the packet characteristic rule; and
when the security mode has been set to a “low” level, it is determined that the packet will be allowed if the packet satisfies the system rule.

13. The method of claim 12, wherein the generating comprises:
extracting fields of specific headers of the collected packet, and generating the system rule using information of the corresponding fields;
extracting fields of specific headers of the collected packet, and generating the communication flow rule using information of the corresponding fields; and
extracting fields of a specific header of the collected packet, and generating the packet characteristic rule using information of the corresponding fields.
